(19) United States
(12) Patent Application Publication
(10) Pub. No.: US 2004/0148424 A1
(43) Pub. Date: Jul. 29, 2004

(54) Digital media distribution system with expiring advertisements

(76) Inventors: Aaron Berkson, New York, NY (US); Stefan Nadarajah, New York, NY (US)

Correspondence Address: WILLIAM COLLARD, COLLARD & ROE, P.C., 1077 NORTHERN BOULEVARD, ROSLYN, NY, 11576, US

(21) Appl. No.: 10/350,569

(22) Filed: Jan. 24, 2003

(51) Int. Cl. G06F 15/16

(52) U.S. Cl. 709/236; 709/217

(57) ABSTRACT

A method and system for distributing “free” media content via a network or the internet, whereby media content files are bundled with advertisements that automatically expire and can automatically resurrect and/or update themselves. The nature of the expiration/resurrection/updating of these advertisements is based on a pre-defined number of impressions, a preset time limit and/or other usage protocols included in the header information of the file which are interpreted and enforced by a media player and/or other software/hardware components The distribution model for this system supports client-server models, peer-to-peer models and other networked models such as digital kiosks. This system supports media content that is linear (e.g. purely audio or audio/visual) and/or non-linear (e.g. interactive games, software, etc.) and this methodology can apply to any compression format of such content. This system can also incorporate appropriate security measures to prevent users from abusing the system.

### BACKGROUND OF THE INVENTION

1. Field of the Invention

The invention relates generally to digital media distribution and the Internet, and specifically to a methodology by which such media content is bundled with expiring advertisements. This provides an advertising/sponsorship revenue stream for the content owners/authors and digital distributors, while providing consumers with “free” media content and a proprietary stake therein.

2. The Prior Art

Since the advent of the Internet, businesses have been trying to establish a viable business model for distributing audio and audio/visual content across the Internet, all of which are problematic for numerous reasons.

In the past problems with the quality and accessibility of online audio and audio/visual content downloads arose due to bandwidth limitations and inferior compression technology. However, vast technological improvements have been and are continuing to be made. In the audio arena, for example, the MP3 compression format provides close to CD quality sound files that can be transferred via narrowband connections in a relatively short amount of time. Similar strides have been made in the audio/visual arena (e.g., MPEG, Real Video, etc.). Furthermore, many new devices are being invented to store and/or playback such content (e.g., portable MP3 players). Moreover, the combination of ever-improving compression technology, new content storage/playback devices and more widespread broadband internet connections is eliminating the problems of quality of experience, accessibility and download times. At the same time, it is providing a burgeoning marketplace for content authors, owners, consumers and advertisers. Importantly, however, businesses seeking to operate in this market have yet to establish a viable business model that satisfies the needs of the aforementioned parties.

The predominant Internet culture is open-source and community oriented, which has created a user expectation of free access and downloads (e.g. all of the shareware available online). This cultural expectation is strongly evidenced by the enormous popularity of peer-to-peer, file-swapping services and similar services. These peer-to-peer swapping of music files enable users to download files for free. The failure of this system is that it does nothing to compensate the owners/authors of the content and some such services have recently been court ordered to shut down due to piracy and copyright infringement issues. However, the success of this system is that it highlights the huge demand for free downloadable content and the establishment of a new computing paradigm (peer-to-peer). Businesses, including the Big Five record companies, have since been scrambling to meet this demand by seeking viable alternatives to the “free model”.

The Big Five record companies have launched services which use a subscription model for the online distribution of media content. The main problem of such a subscription model is that it fails to meet the existing cultural expectation of getting such content for free on the Internet. Also, customers may be reluctant to pay for myriad reasons: inferior quality of content to that available offline, reluctance to divulge credit card information online, inability to pay by credit card (e.g. the largest market for free downloadable music is currently college students). Note: similar problems exist for purchase models. Furthermore, the Department of Justice is scrutinizing the record companies' online ventures for potential antitrust issues.

Another alternative is a broadcast model, analogous to television or radio, whereby content is in a single linear stream and the advertisements are embedded within the stream. The main problem with this model is that the users lack any proprietary stake in the content, thus limiting their control over the experience.

Finally, a major underlying problem relates to the Internet advertising industry and its inability to effectively target consumers and reach target markets. The predominant forms of Internet advertising are pop-up and banner ads which are visually displayed on various web pages, in pop-up windows and/or in DHTML pop-up layers. Such advertisements are usually placed on sites with narrow audiences or specific content in order to increase the chances of “hitting” the target consumer. However, such methods are often unreliable, and banner ads are easily ignored by site users, who often view such ads as an irritation or distraction. Pop-up ads are overly obtrusive and are also often immediately closed and ignored by users. Furthermore, such an approach does not provide the advertiser with accurate feedback on ad success rates, demographic information, etc. Therefore, due to ineffective online advertising methods, online ad revenue has plummeted (a major contributing factor to the dot-com bubble burst).

U.S. Pat. No. 6,216,112 B1 to Fuller et al discloses a method for software distribution and compensation with replenishable advertisements. U.S. Pat. No. 6,248,946 to Dwek discloses a multimedia content delivery system and method. U.S. Pat. No. 6,119,098 to Guyot et al discloses a system and method for targeting and distributing advertisements over a distributed network. However, these software distribution systems fail to bundle free downloadable media files with expiring advertisements. The present invention does employ this method, providing a benefit to content owner/author, digital distributor, advertiser, and consumer.

### SUMMARY OF THE INVENTION

In sum, the invention realizes significant advancements in addressing the aforementioned problems by bundling automatically expiring advertising content with a specific piece or specific pieces of media content. It is submitted that this invention relates to a method, model or system which addresses the needs of all interested parties and may be implemented in combination with any other model or as a stand alone model. Examples of such other models include but are not limited to the option of paying to disable advertising content, integrating the invention into ISP software, or integrating the invention into ISP software and augmenting advertising revenue with an additional subscription fee, to be bundled with the cost of ISP Software.

The present invention relates to the distribution of a bundled content file of digital media for use with a media player. The content file has header information which contains rules by which the media content file can be played on the media player, as well as content identifiers and usage information. The content file also contains primary media content and primary advertisement content. The primary advertising content must be played in order to play the primary media content.

The digital media content is distributed over a network or the Internet. First the media content, advertising content and header information is bundled into a single media file. A central server regulates and enables the downloading(/streaming) of bundled files via media player/enforcement software. Users download the bundled file to a client device. The central server maintains and updates a content library, tracks the number of downloads and users, and other usage information. The primary advertising content expires once the expiration rules in the header information have been complied with by the user.

The benefit to the consumer is that the consumer may download media content for free. The consumer, in return, will be exposed to a corresponding advertisement that will expire according to preset protocols. The consumer will then permanently enjoy almost complete control over that piece of media content (e.g. burn it to CD/DVD/DVD-audio, transfer it to another peer, download it to a portable media device, etc. Note: see security/anti-piracy measures below). This invention is therefore aligned with Internet users' cultural expectations and demand for free downloads.

The benefit to the content authors and owners is that they will be reimbursed for the distribution of that content by advertising/sponsorship revenue. Moreover, with improvements in compression technology and an increasing number of broadband connections, they will be able to tap into a rapidly growing market for free digital media content. For example, the (“Big Five”) major record companies could leverage their deep content repositories to not only meet existing demand, but to create new demand. An alternate example is that content authors (e.g. independent artists) could use such a distribution model to directly reach a large audience, thereby disintermediating record labels, publishers, etc.

The benefit to the advertising industry is that this invention provides an entirely new advertising space, with an effective method of targeting consumers. The advertisers can gather an abundance of demographic information from a consumer by virtue of what piece of content was downloaded. Furthermore, extensive usage records can be maintained in order to track the use or success of a particular advertising content. Also, this advertising model allows the advertisers to seamlessly integrate advertisements in the same medium as the media content (e.g. audio-only ad for audio-only media content). Compare banner ads.

A significant aspect of this invention is its ability to safeguard against potential abuse of the system, beneficial to both content owners/authors and advertisers. First, in order to limit the ability of a user to bypass the advertisement experience before expiration, preset rules within the media file and/or the media player may be configured to govern items ranging from volume setting to frequency of advertising impressions within a set time frame. Ads may also be updated after a pre-determined time period; thus, advertisers can place a strict time limit on the validity of an ad. Furthermore, should the user wish to digitally transfer a content file to a peer, the advertising content will “resurrect” itself, even if the ad had expired for the original user. Should the user wish to transfer the media file to a CD, portable media player, etc., specific rules may be set to govern such activity.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an example of the file structure of a bundled media file;

FIG. 2 shows a flow chart for a bundling process of a bundled media file for client-server transmission;

FIG. 3 shows a flow chart for a bundling process of a bundled media file for client-server/peer-to-peer transmission;

FIG. 4 shows a flow chart of rules enforcement involving the playing of a bundled media file;

FIG. 5a shows a client/server transmission of a bundled media file;

FIG. 5b shows a peer-to-peer transmission of a bundled media file;

FIG. 5c shows a hybrid client-server/peer-to-peer transmission of a bundled media file;

FIG. 6a shows a client-server/peer-to-peer hybrid conversion of downloaded non-bundled formats;

FIG. 6b shows a client-server/peer-to-peer hybrid conversion of downloaded non-bundled formats and streaming advertising content;

FIG. 7a shows a client/server transmission of streaming media and advertising content;

FIG. 7b shows a client/server transmission of a downloaded bundled media file with streaming advertising content;

FIG. 8 shows a client-server/peer-to-peer hybrid transmission of a bundled media file with streaming advertising content; and

FIG. 9 shows a flow chart of CD/DVD/DVD-audio/data disc writing a bundled media file to CD (or other media).

### DETAILED DESCRIPTION OF THE PREFERRED EMBODIMENT

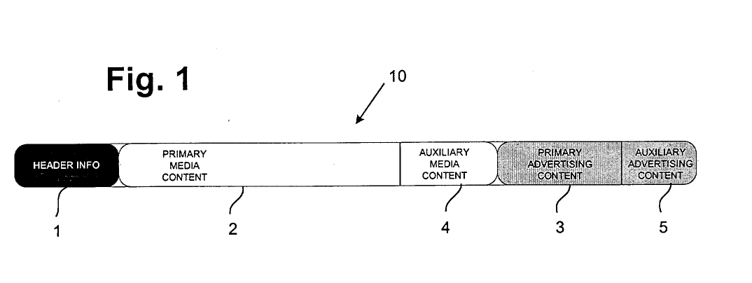

Referring in detail to the drawings, FIG. 1 shows the file structure of a bundled media file. The core of this invention involves bundling media content files with expiring advertisements and setting rules within the file and/or media player to govern a variety of functions.

The following is a non-exhaustive list of media file components: Header Information 1, Primary Media Content 2, Primary Advertisement Content 3, Auxiliary Media Content 4, and Auxiliary Advertisement Content 5.

Header information 1 contains all the data that define the identifiers for the content, the rules by which media 2, advertisement 3, and auxiliary content 4,5 may be viewed or listened to or interacted with, and possibly the usage information (which may also be stored in the media player). These rules are then interpreted by the media player (be it software or hardware).

The identifiers/descriptors for this content could include any or all such information as a unique ID number, content type (audio or audio/visual), content sub-type (e.g. music album or music single), title, author, copyright owners, date of publication, rating, length of content, compression format, number of advertisements, ad playback type, number of impressions/time frame required for advertisements, expiration date for advertisements 3,5, description of auxiliary media content 4, description of auxiliary advertisement content 5 etc. This list of identifiers changes depending on the content type and sub-type. An example of content type could be linear or non-linear and the sub-type is a further definition of the primary content type. For example, the content sub-type could differentiate between full-length feature movie and a television show.

The rules definition information defines the conditions under which the advertisement content expires, updates and/or resurrects itself and defines other conditions such as security/anti-piracy functions and “pay to disable ad” functions. These functions can be defined across several parameters.

The usage information tracks exactly how the file is being used: how many times advertisement 3,5 has been experienced, how many times media content 2,4 has been experienced, the degree to which primary media content 2, auxiliary media content 4, ad content 3 and/or auxiliary ad content 5 has been experienced.

Primary media content 2 is the primary portion of the file, and contains the actual media content that the consumer wishes to experience. This content could be audio only, audio/visual and/or interactive. Primary media content 2 could be in any compression format, including compression formats that have yet to be conceived. (For audio, compression format could include formats superior to CD quality sound, such as DVD-audio format.)

Primary advertisement content 3 may be in either audio or audio/visual or interactive format. Primary advertisement content 3 could be experienced prior to experiencing primary media content 2, after experiencing primary media content 2, or intermittently throughout the playback of primary media content 2. Primary advertisement content 3 could contain one advertisement promoting one product or service, several ads promoting different products and services, or several ads promoting the same product/service.

Auxiliary media content 4 is auxiliary to primary media content 2 and is optional. This content is analogous to content currently offered on “Enhanced” Audio CDs or “Bonus Features” on DVD titles. Auxiliary media content 4 may also include types of auxiliary interactive and non-interactive content yet to be conceived or yet to be widely used; examples include album artwork, lyrics, liner notes, sound/music visualizers, interactive content (such as “interactive album covers”) or other features that would help enhance the digital experience.

Within a piece of Auxiliary Media Content 4, there could be additional Auxiliary Advertisement Content 5 bundled, which would be optional overall, but not optional if the user wishes to experience the given piece of Auxiliary Media Content 4. An example would be an audio/visual experience (a flash animation for example) with an official sponsor.

Auxiliary advertisement content 5 is auxiliary to the primary advertisement content 3 and is optional with the exception to Auxiliary Advertisement Content being optional described above. This could include detailed product/service information (or simply a URL to such info), interactive content such as games, or additional audio or audio visual content that further promotes the product or service to the consumer. This auxiliary advertisement content 3 may also correspond to multiple products/services being promoted.

Rules for playback are set out in header information 1 of a given file, and those rules are enforced by the media player and/or other software components which interpret the rules described in header information 1. Tracking information for playback is stored by the media player and may also be stored in header information 1 of media file 10. The rules in header information 1 are stored via a series of descriptors. The number of descriptors would be of variable length, depending on the exact configuration. Examples of such descriptors range from a unique ID number to content type. Examples of content types could include: audio-only, audio-visual, interactive, software, etc. Appropriate security and encryption technology would also be used to ensure the rules are not broken.

Primary media content 2 of the file could be purely interactive content such as a game or software program as opposed to linear media content such as an audio track or film. This would be an exception to general relationship of Media Content file 10 and the Media Player. In this case, the file itself would act as its own “media player”, thus enforcing the rules of use. However, the user would still be required to experience advertisement content according to such pre-set rules.

Primary and auxiliary advertising content 3,5 are bundled with primary and auxiliary media content 2,4 prior to users downloading. For example, one audio ad could be matched with a particular audio track. Alternatively, one piece of advertising content could be associated with a collection of multiple pieces of media content. For example, one ad could apply to an entire album or even a collection of songs/movies/etc. that are from completely different sources (e.g. a user could download five songs by five different artists and only have one piece of advertising content associated with them, thus forcing the user to experience that ad content if any or all five songs are chosen).

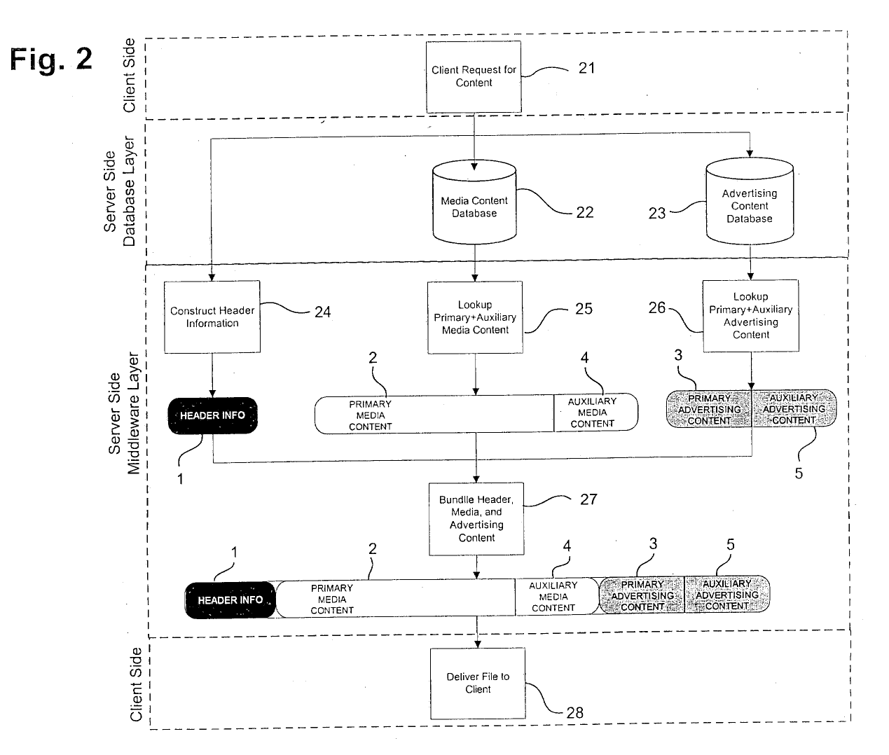

FIG. 2 shows a bundling process for a bundled media file for client-server transmissions. The client first requests the content of the file in step 21. In the database layer of a server, a media content database is contacted in step 22 as well as an advertising content database in step 23. In a middleware layer of a server, header information 1 is constructed in step 24. Further, primary media content 2 and auxiliary media content 4 are looked up in step 25. Primary advertising content 3 and auxiliary advertisement content 5 are also looked up in step 26. Header information 1, primary and auxiliary media content 2,4, and primary and auxiliary advertising content 3,5 are then bundled in step 27. Finally, media file 10 is delivered to the client in step 28.

Additionally, for a given collection of media content, different pieces of Advertising Content could be associated with the entire collection, or a sub-set of that collection. For example a first ad could be associated with Disc 1 of a double album, a second ad could be associated with Disc 2 of a double album, and a third ad could be associated with the entire album. A collection of multiple pieces of content could consist of multiple media types, such as one movie combined with 10 songs and one interactive game.

The advertising content could also be re-bundled on a timely basis, for example, to maintain the system's compliance with advertisers' requirements. After a user has downloaded a file, the system could also update advertising content and header information directly to a user or at the time of peer-to-peer sharing using proprietary software associated with the media player (see TRANSMISSION SITUATIONS below).

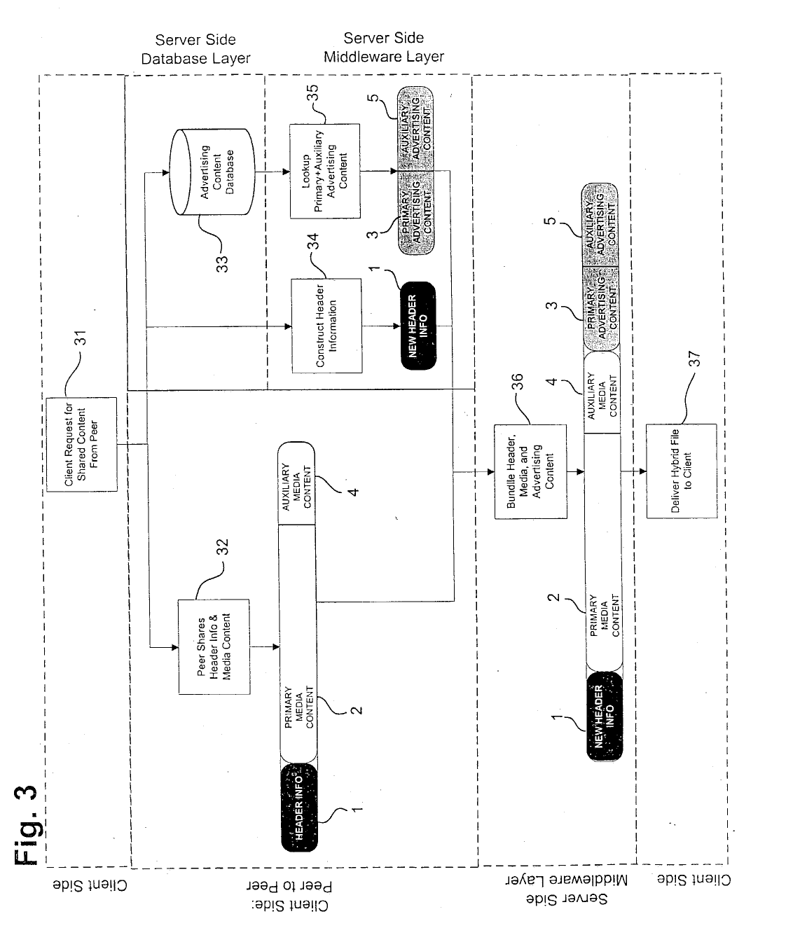

FIG. 3 shows a bundling process for a bundled media file 10 for client-server/peer-to-peer transmissions. In a first step 31, a client first requests shared content from a peer. The peer shares header information 1, primary media content 2, and auxiliary media content 4 in step 32. An advertising content database of a server is contacted in step 33 and primary and auxiliary advertising content 3, 5 are looked up in a middleware level of the server in step 35. The server also constructs new header information 1 in step 34. New header information 1, primary and auxiliary media content 2,4 and primary and auxiliary advertising content 3,5 are then bundled in step 36 and delivered in step 37 to the requesting client.

The media player/enforcement software is crucial to interpreting all of the different pieces of information contained in the file. It may also keep track of usage information, including number of impressions, advertisements expiration rules, etc. and reports such data back to the central server (usage information can also reside in the header information). Furthermore, it enables users to playback the files they receive and also enforces the playback rules. On a personal computer, the media player/enforcer could exist as a browser-based application, and browser plug-in, or as a stand-alone OS-based application. The interface of the media player would also serve to instruct and inform users on usage rules pertaining to a given file. Appropriate security and encryption technology would be used to prevent the media player from being abused (i.e. circumvention of the enforcement of playback rules).

The media player/enforcement software also regulates and enables the download of files and the peer-to-peer sharing of files. The software could also include community-based technology, media management and/or personalization technology to enhance the user experience. For example, the software could also include “push” based technology based on user preferences (e.g. delivering/suggesting new media content files in same genre that the user requests).

Finally, the media player/enforcement software could be incorporated into existing media players (e.g. Windows Media, Real Player, Quicktime, etc.) and other software applications such as ISP OS-based software (e.g. AOL, Broadband Software Services, DSL Software services, etc.). The media content files themselves could also be incorporated into those existing media formats, employing the business rules and technology specified in this invention.

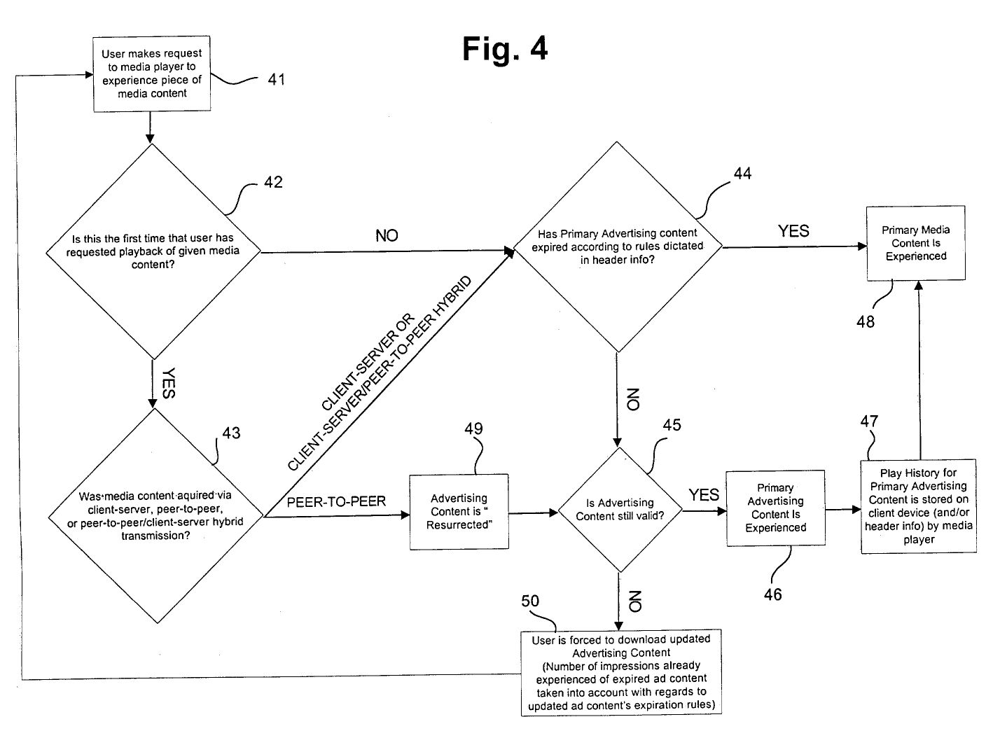

FIG. 4 shows a flow chart of rules enforcement involving the playing of bundled media file 10. In first step 41, a user first makes a request to experience media content. Step 42 then determines whether this is first time that the user has requested playback of given media content. If this is the first time it is analyzed, step 43 determines whether the media content was acquired by client-server, peer-to-peer, or peer-to-peer/client-server hybrid transmission. If the content was acquired via client-server or hybrid transmission, step 44 determines whether primary advertising content 3 expired according to the rules dictated in header information 1. If the advertising content has not expired, step 45 determines whether the advertising content is still valid. If the content is still valid primary advertising content 3 is experienced in step 46. The play history for primary advertising content is then stored in step 47 on client device and/or header information by media player. Primary media content 2 is then experienced in step 48.

If the primary advertising content had expired according to the rules in header information 1, primary media content 2 is experienced in step 48.

If the media content was acquired via peer-to-peer transmission advertising content is resurrected in step 49 and step 45 determines whether the advertising content is still valid. If the advertising content is no longer valid the user is forced to download updated advertising content in step 50.

In addition to personal computers, the content files and media player/enforcer could reside in hardware or software form on other devices; these include but are not limited to PDAS, stand alone hardware player (i.e. non-portable hardware device), standalone portable players, Kiosks, or Set top boxes.

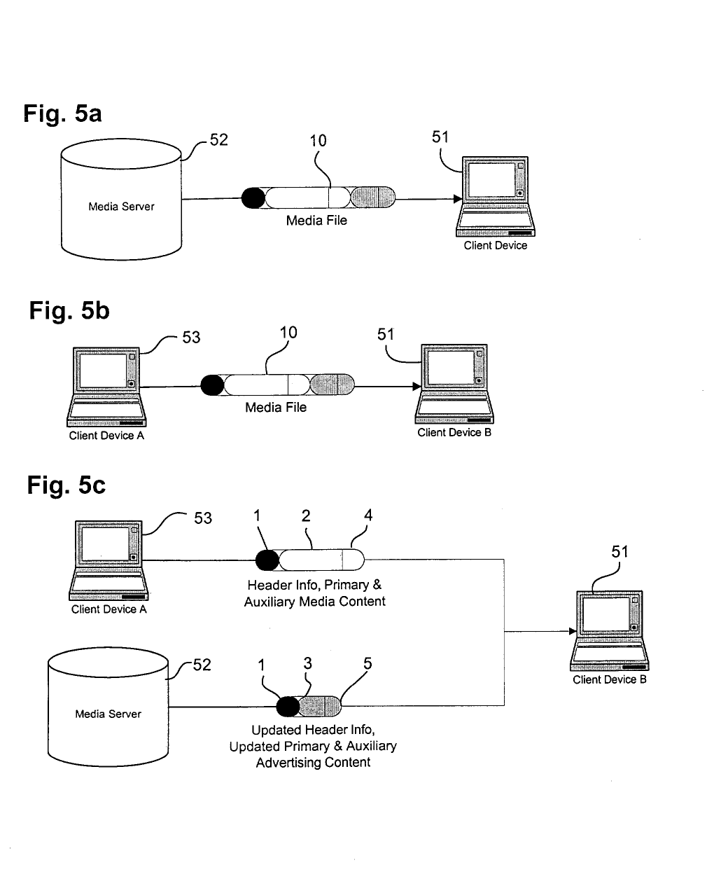

There are two basic distribution models that this methodology may be applied to: Client-Server as shown in FIG. 5a and Peer-to-Peer as shown in FIG. 5b. In either case, users would access files through a client device 51. This device could be a software program, either browser based (including simply using http and/or ftp transfer protocols) or OS based, or it could be a hardware device, which could be a stationary or portable device. In all cases, communication could be wireless or through a land line, cable modem, DSL, T1, etc.

In the client-server case, the consumer, using client device 51 would download a piece or collection of media content 10 bundled with expiring advertisements 3,5 to their client device from a central server 52. Server 52 would maintain and update the content library, including advertisements 3,5 associated with pieces of content and the rules associated with expiration, resurrection, updating and other functions of the various content components. Server 52 would also track number of downloads, users associated with those downloads, etc. Users of the service may have to register and/or provide some personal information. In order to provide a compelling service, the content repository should be deep and current and may include chat/community and e-commerce (i.e. merchandise e-stores) functions.

In the peer-to-peer case, files are transferred from client-device A53 to client-device B51. The media player/enforcement software would be able to deduce from header information 1 and usage information that the receiver of the file had not experienced any advertising content 3,5, even if the sender of the file had already experienced all required advertising content 3,5. In this case, the media player would “resurrect” advertising content 3,5, if still valid due to time restrictions, and require to the new receiver of the file to experience advertising content 3,5. Additionally, advertising content 3,5 itself could be replaced or updated. For example, if the advertisers place a strict time limit on the validity of their advertisement, and that time limit elapses, the entire file would be considered invalid and the media player would refuse to play the file. The user would be directed to central server 52 version of same media content 10 and could automatically download that file from central server 52 with the updated ad.

A third type of transfer shown in FIG. 5c is a hybrid between client-server and P2P. This transfer involves the P2P sharing (client device to client device) of primary and auxiliary media content 2,4 coupled with updated primary and auxiliary advertising content 3,5 that would concurrently come in from central server 52 (client-server) and be bundled with primary and auxiliary media content 2,4 being transferred P2P. The result would be a new file on the receiving user's end with the shared media content and the updated advertising content.

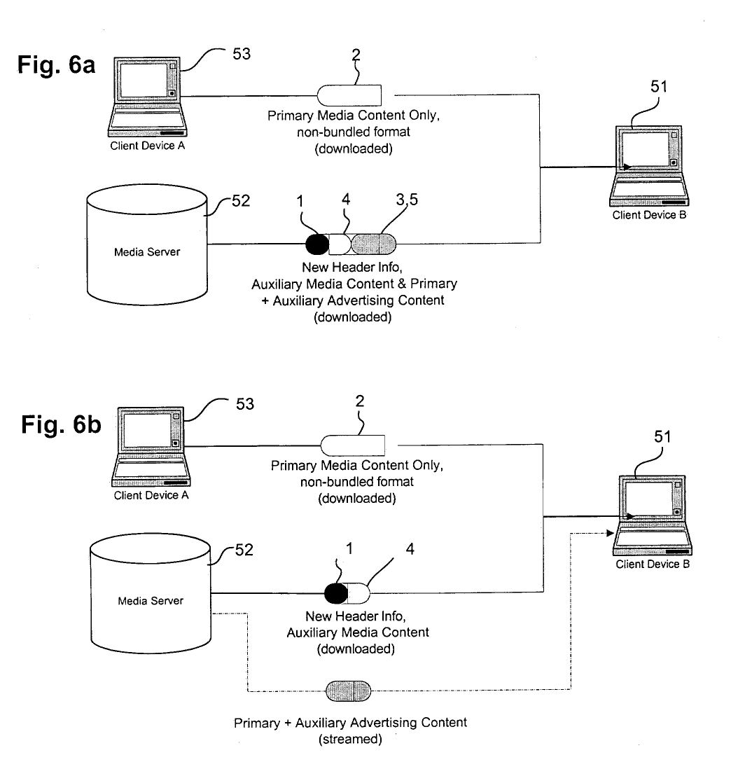

In this hybrid transmission case, it is also possible to incorporate the sharing media files that are not in a format that allow for bundling of expiring advertisements (e.g. MP3, WAV, etc.) as shown in FIGS. 6a and 6b. In this case, the content contained in the non-bundled file 2 would be combined with new header information 1 and advertising content 3,5 in another file with a format that allows for bundling of expiring advertisements (and auxiliary content); this newly created bundled file would then be delivered to receiving client device 51. More specific information about the initial non-bundled file 2, which would aid in determining the type of advertisement and auxiliary media content it would be bundled with it, could be determined through a variety of methods, including looking up information based on file name in the media server or the actual “fingerprint” of the data contained in the file (e.g. shape of sound wave, images contained in frames, etc.).

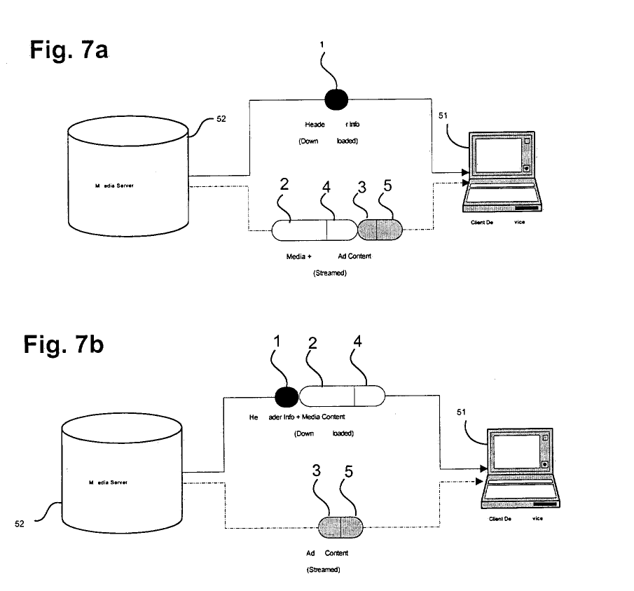

In addition to the above description of download methods, it would be possible for advertising content 3,5 and/or media content 2,4 to be streamed instead of downloaded, in which only header information 1 would actually be downloaded to client device 51 as shown in FIG. 7a. The user experience could be identical to the file downloading method, if the streaming was instantaneous through a persistent high-bandwidth connection. In the case of both advertising content 3,5 and media content 2,4 being streamed, only client-server would apply; the peer-to-peer, client-server/peer-to-peer hybrid, and data copying cases would not be applicable.

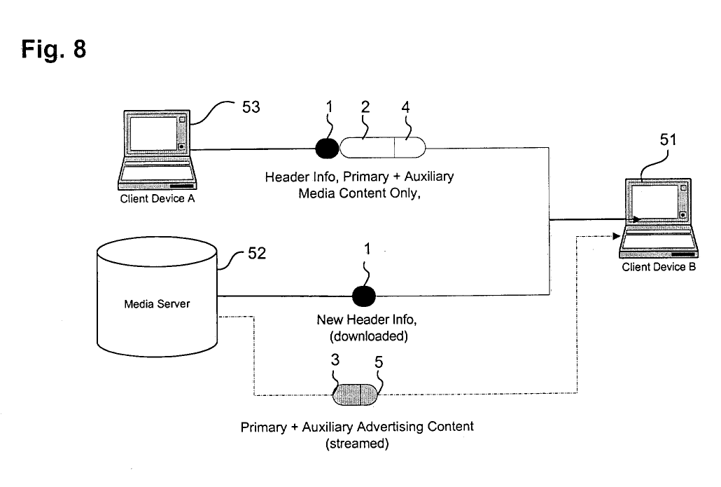

In the case of advertising content 3,5 being streamed and media content 2,4 being downloaded, client-server as shown in FIG. 7b, peer-to-peer, and client-server/peer-to-peer hybrid as shown in FIG. 8 would all be applicable but would require a persistent connection to the media server to stream advertisements; the data copying in this case, to a device not connect to the media server, would only be possible if advertising content 3,5 had expired. In both previously stated examples where advertising content 3,5 is streamed, the concept of ad resurrection is no longer applicable. The above mentioned streaming cases differ from an online radio model method since users in an online radio model experience a linear stream of content that they have little or no control over, whereas in the above described method is “non-linear” whereby users have almost complete control over content experienced.

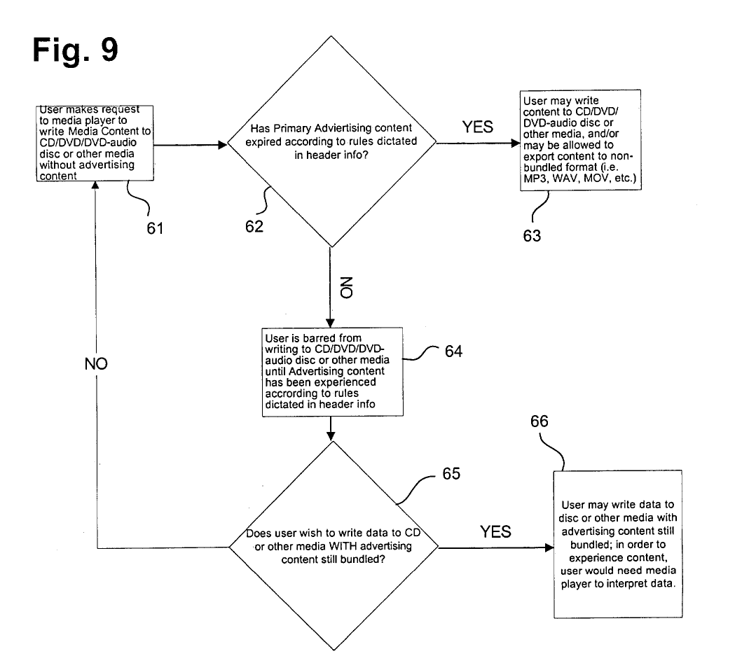

As shown in FIG. 9, once users have acquired content files, the client device may allow those users to copy that data to a portable or hard-copy medium such as floppy disks, zip disks, CDs, DVDs, DVD-audio, etc. In the case of burning to CD/DVD/DVD-audio/data discs, data could be burned to CD/DVD/DVD-audio/data disc with advertising content still bundled (as a data disc) and would require special CD/DVD/DVD-audio/data disc players, that could interpret the rules in the header information, to play those files. Another option is that users could burn media content to a CD/DVD/DVD-audio disc without advertising content (after advertising content has expired for that user). These CD/DVD/DVD-audio discs could be copy-protected or incorporate other security measures. Another alternative is that users could only burn a finite number of CD/DVD/DVD-audio discs in a given timeframe. The aforementioned conditions may be employed on a case-by-case basis or by consistent operating standards.

The first step 61 in writing to a CD/DVD/DVD-audio disc is a user makes a request to a media player to write media content 2,4 to a CD/DVD/DVD-audio disc without advertising content 3,5. The following step 62 determines whether primary advertising content 3 has expired according to the rules dictated in header information 1. If primary advertising content 3 has expired, a user may write content to a CD/DVD/DVD-audio disc in step 63. If primary advertising content has not expired the user is barred from burning a CD/DVD/DVD-audio discs until advertising content 3 has been experienced according to the rules dictated in header information 1 in step 64.

Step 65 determines whether a user wishes to write data disc with advertising content 3 still bundled. If so the user may write data to a disc with advertising content still bundled in step 66. In order to experience the content a user would need a media player to interpret the data.

In addition to CD/DVD/DVD-audio writing, users could be allowed to export ad-expired files into non-bundled formats (i.e. MP3, WAV, etc.)

Advertising content expires according to one or a combination of any or all, but not limited to, the following rules:

1. for a given number of impressions (e.g. expiration after five ad impressions)

2. within a given time period (e.g. expiration after one month of download)

3. a number of impressions within a given time period; for instance, if the advertisement were experienced 5 times in a row, it would only count as one impression; a certain time period would have to elapse between impressions for those impressions to be added to the number of required impression.

In the case that all the required advertising has been experienced by a user, the primary and auxiliary advertising content then expires and lays dormant. In other words, that particular user is no longer required to experience the advertising content and thus may enjoy the primary media content as the de facto “owner” of that piece of content. The user may retain the option to access the dormant primary and auxiliary advertising content up until such content's prescribed validity date, after which it may be deleted by the media player/enforcer.

Ad resurrection automatically occurs when a media player/enforcer recognizes that certain rules embedded in the header information of the file have not been complied with. For example, if a file were transferred from client device to client device (P2P), the recipient client device's media player/enforcer would match its usage records with the rules embedded in the file's header information and determine that said playback/usage rules have yet to be complied with.

The media player may or may not access the central server to update primary and auxiliary advertising content and re-bundle it with media content at any time. (Though it may be preferable for this not to happen during playback itself due the adverse user experience that may be caused due to an interruption of a smooth playback experience).

If a user has not experienced all the required advertising content within the timeframe required, the file may be considered invalid, and new advertising content would be required to be re-bundled in order to allow the user to experience the media content. Until that re-bundling takes place, the media player would disallow playback of that media content.

Users may or may not be allowed to disable advertising content via payment. In this case all bundled advertising content would be deleted. All appropriate security and encryption methods would be employed in these commerce transactions.

Anti-piracy safeguards include but are not limited to the following: secure and encrypted file transfer and enforcement of rules for playback; CD/DVD/DVD-audio disc burning in a copy-protected format; data configuration (i.e., not continuous data).

Anti-ad bypass measures include but are not limited to the following: minimum volume setting during ad playback; prohibition on users to mute or move volume below that minimum; prohibition on fast-forwarding or skipping through advertising content; detection of measures employed to avoid experience content; (i.e., disabled soundcard, sound or video system disconnected, etc.); prohibition on “looping” of media content whereby users would simply play media content constantly in a row so that advertisement content expires immediately.

Accordingly, while several embodiments of the present invention have been shown and described, it is obvious that many changes and modifications may be made thereunto without departing from the spirit and scope of the invention.

What is claimed is:

1. A bundled content file for digital media distribution and for use with a media player comprising:
header information having rules by which the media content file can be played on the media player, as well as identifiers of the content, and usage information;
primary media content; and
primary advertisement content;
wherein said primary advertisement content must be played in order to play said primary media content.

2. The bundled media content file according to claim 1, wherein said identifiers of the content comprise one or more of the following: an ID number, content type, content sub-type, title, author, copyright owners, publication date, rating, length, compression format, number of advertisements, advertisement playback type, and number of impressions/time frame required for advertisements, and expiration date for advertisements.

3. The bundled media content file according to claim 1 wherein said rules in said header information define conditions under which said primary advertisement content expires, updates or resurrects.

4. The bundled media content file according to claim 3, wherein said rules in said header information further define security/anti-piracy functions and “pay to disable ad” functions.

5. The bundled media content file according to claim 1, wherein said usage information stores the number of times said primary advertisement content and said primary media content have been played.

6. The bundled media content file according to claim 1 wherein said primary media content is audio, audio/visual, or interactive.

7. The bundled media content file according to claim 1, wherein said primary advertisement content is audio, audio/visual, or interactive.

8. The bundled media content file according to claim 1, wherein said primary advertisement content is played before, after or intermittently through said primary media content.

9. The bundled media content file according to claim 1, further comprising auxiliary media content.

10. The bundled media content file according to claim 1, further comprising auxiliary advertisement content.

11. A method of distributing digital media content via a network or the Internet comprising:
bundling primary media content with header information and primary advertising content;
regulating and enabling the download of files via media player/enforcement software;
moving said primary media content bundled with said primary advertisement content to a client device from a central server;
maintaining and updating a content library as well as tracking the number of downloads and users via said central server; and
expiring said primary advertising content after moving to said client device once rules in said header information have been complied with.

12. The method of distributing media content according to claim 11, further comprising the step of invalidating the media content if a user has not experienced said advertising content in accordance with said header information.

13. The method of distributing media content according to claim 11, further comprising the step of establishing anti-advertisement bypass measures.

14. The method of distributing media content according to claim 11, further comprising the step of rebundling said primary advertisement content to maintain the systems compliance with advertisers' requirements.

15. The method of distributing media content according to claim 11, further comprising the step of informing and instructing users on usage rules for the downloaded file.

16. The method of distributing media content according to claim 11, further comprising the step of incorporating media player/enforcement software into an existing media player.

17. The method of distributing media content according to claim 11, further comprising the steps of:
sharing files from a first client device to a second client device;
deducing from said header information and said usage information that said second client had not experienced said primary advertisement content;
resurrecting said primary advertisement content; and
requiring said second client to play said primary advertisement content according to said rules in said header information.

18. The method of distributing media content according to claim 11, further comprising the step of updating said primary advertisement content.

19. The method of distributing media content according to claim 11, further comprising the step of copying said downloaded files to a portable or hard-copy medium with said primary advertisement content still bundled.

20. The method of distributing media content according to claim 11, further comprising the step of copying said downloaded files to a portable or hard-copy medium without said primary advertisement content bundled after it has expired.

21. The method of distributing media content according to claim 11, further comprising the step of permitting users to copy a finite number of CD/DVD/DVD-audio discs in a given time frame.

22. The method of distributing media content according to claim 11, further comprising the step of expiring said primary advertisement content as defined by said header information after a defined number of impressions.

23. The method of distributing media content according to claim 11, further comprising the step of expiring said primary advertisement content as defined by said header information after a given time period.

24. The method of distributing media content according to claim 11, further comprising the step of expiring said primary advertisement content as defined by said header information after a defined number of impressions in a defined time period, wherein a certain time must elapse between playing of said primary advertisement content.

25. The method of distributing media content according to claim 12, further comprising the step of disallowing playback until rebundling takes place if a file has been invalidated.

26. The method of distributing media content according to claim 11, further comprising the step of disabling said primary advertisement content by making a payment.

27. The method of distributing media content according to claim 11, wherein said primary media content originates from another client device in a nonbundled form before bundling with said header information and said advertisement content.

28. A method of distributing digital media content via a network or the Internet comprising:
bundling primary media content with header information;
regulating and enabling the download of files via media player/enforcement software;
moving said primary media content to a client device from a central server;
streaming primary advertisement content to a client device from a central server;
maintaining and updating a content library as well as tracking the number of downloads and users via said central server; and
expiring said primary advertising content once rules in said header information have been complied with.

29. The method of distributing media content according to claim 28, further comprising the steps of:
sharing files from a first client device to a second client device;
deducing from said header information and said usage information that said second client had not experienced said primary advertisement content;
moving new header information from said central server to said second client device;
streaming said primary advertisement content from said central server to said second client device; and
requiring said second client to play said primary advertisement content according to said rules in said new header information.

30. The method of distributing media content according to claim 28, wherein said primary media content originates from another client device in a nonbundled form before bundling with said header information.

31. A method of distributing digital media content via a network or the Internet comprising:
regulating and enabling the download of files via media player/enforcement software;
moving header information from a client device from a central server;
streaming said primary media content and said primary advertisement content to a client device from a central server;
maintaining and updating a content library as well as tracking the number of users via said central server; and
expiring said primary advertising content after moving to said client device once rules in said header information have been complied with.

32. An article of manufacture comprising:
a computer usable medium having a machine readable program code means for bundling primary media content with header information and primary advertising content;
a machine readable program code means for tracking usage information as well as regulating and enabling the download of files via media player/enforcement software;
a machine readable program code means for moving said primary media content bundled with said primary advertisement content to a client device from a central server;
a machine readable program code for maintaining and updating a content library as well as tracking the number of downloads and users via said central server; and
a machine readable program code for expiring said primary advertising content after moving to said client device once rules in said header information have been complied with.
